(19) United States
(12) Patent Application Publication
(10) Pub. No.: US 2026/0161014 A1
(43) Pub. Date: Jun. 11, 2026

(54) AERIAL IMAGE DISPLAY DEVICE

(71) Applicant: KYOCERA Corporation, Kyoto-shi, Kyoto (JP)

(72) Inventors: Ryo TADAUCHI, Otsu-shi, Shiga (JP); Kazuki SHIMOSE, Yasu-shi, Shiga (JP); Hiroyoshi KAWANISHI, Sanda-shi, Hyogo (JP)

(21) Appl. No.: 19/150,104

(22) PCT Filed: Jan. 17, 2024
(86) PCT No.: PCT/JP2024/001177

§ 371 Date: Jul. 22, 2025

(30) Foreign Application Priority Data
Jan. 25, 2023 (JP) 2023-009653

(51) Int. Cl. G02B 30/56; G06T 5/90; H04N 13/122; H04N 13/302

(52) U.S. Cl. CPC G02B 30/56; G06T 5/90; H04N 13/122; H04N 13/302

(57) ABSTRACT

An aerial image display device includes a display device, an optical system, and a distance-varying portion. The optical system forms, as a real image, an aerial image from image light emitted from the display device. The distance-varying portion is located opposite to an eye of a user across the aerial image and at a defocus position for the eye of the user when the eye of the user is at a focus position for the aerial image. The distance-varying portion has a varying distance, by location, from a virtual imaging plane of the aerial image.

### TECHNICAL FIELD

The present disclosure relates to an aerial image display device that can display a three-dimensional aerial image.

### BACKGROUND OF INVENTION

An aerial image display device with a known technique is described in, for example, Patent Literature 1.

### CITATION LIST

### Patent Literature

Patent Literature 1: Japanese Unexamined Patent Application Publication No. 10-186276

### SUMMARY

In an aspect of the present disclosure, an aerial image display device includes a display device, an optical system, and a distance-varying portion. The optical system forms, as a real image, an aerial image from image light emitted from the display device. The distance-varying portion is located opposite to an eye of a user across the aerial image and at a defocus position for the eye of the user when the eye of the user is at a focus position for the aerial image. The distance-varying portion has a varying distance, by location, from a virtual imaging plane of the aerial image.

### BRIEF DESCRIPTION OF THE DRAWINGS

The objects, features, and advantages of the present disclosure will become more apparent from the following detailed description and the drawings.

FIG. 1 is a schematic cross-sectional view of an aerial image display device according to one embodiment of the present disclosure.

FIG. 2 is a side view of the aerial image display device illustrated in FIG. 1, describing its display principle.

FIG. 3 is a graph showing the relationship between the distance from an aerial image to the aerial image display device and a diopter difference.

FIG. 4 is a perspective view of the eyes of a user, the aerial image, and the aerial image display device illustrating their positional relationships.

FIG. 5 is a perspective view of the aerial image display device, illustrating an example appearance.

FIG. 6 is a front view of the aerial image display device.

FIG. 7 is a front view of an aerial image display device according to another embodiment of the present disclosure.

FIG. 8 is a front view of an aerial image display device according to another embodiment of the present disclosure.

FIG. 9 is a front view of an aerial image display device according to another embodiment of the present disclosure.

FIG. 10 is a front view of an aerial image display device according to another embodiment of the present disclosure.

### DESCRIPTION OF EMBODIMENTS

Patent Literature 1 describes an aerial image display device with a known technique that allows a user to focus on an aerial image alone, with a diopter difference |DL−DI|>0.6 being satisfied, where DL is a diopter for a lens array and DL=−1/(a+b), DI is a diopter for the aerial image and DI=−1/b, a (m) is the distance from the lens array to the aerial image, and b (m) is the distance from the aerial image to a viewing position. The technique allows the user to view a clear three-dimensional image.

With the known technique described in Patent Literature 1, the diopter difference |DL−DI| between the diopter DI for the distance between a viewpoint and the aerial image and the diopter DL for the distance between the viewpoint and the lens array is set to a value exceeding 0.6. However, the position of the focal point of the eyes of the user is actually less likely to be fixed on the aerial image. A pop-out distance from the aerial image display device behind the aerial image to the aerial image thus cannot be easily identified accurately. The user thus cannot properly feel the sense of popping-out and the sense of floating of the aerial image. The accuracy of depth recognition is thus low. Aerial image display devices have been awaited for forming an aerial image with an improved sense of popping out and floating and displaying an aerial image with improved accuracy of depth recognition.

An aerial image display device according to one or more embodiments of the present disclosure will now be described with reference to the accompanying drawings.

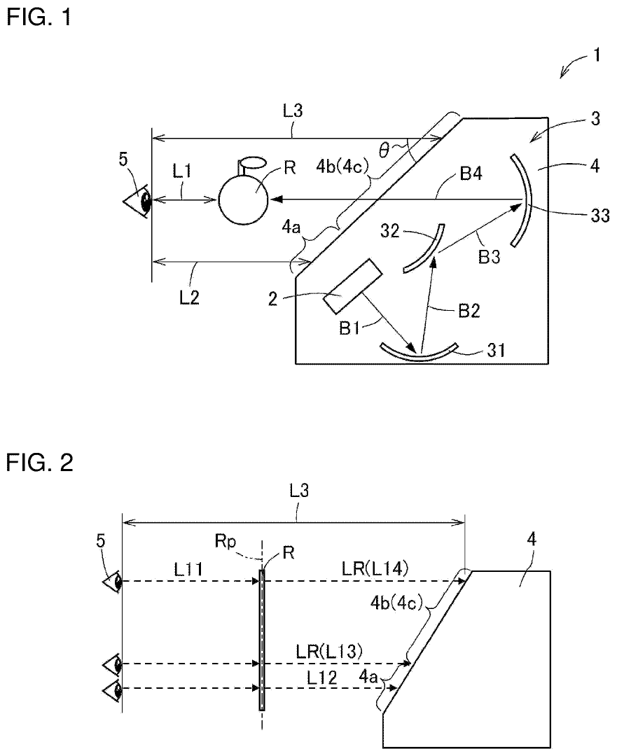

FIG. 1 is a schematic cross-sectional view of an aerial image display device according to one embodiment of the present disclosure. FIG. 2 is a side view of the aerial image display device illustrated in FIG. 1, describing its display principle. In the present embodiment, an aerial image display device 1 includes a display device 2 and an optical system 3 that forms, as a real image, an aerial image R from image light emitted from the display device 2. The aerial image display device 1 may include a housing 4. The housing 4 may be made of a light-shielding panel material, for example, metal such as an aluminum alloy or a synthetic resin such as hard polyvinyl chloride.

The aerial image display device 1 includes a distance-varying portion 4c. When eyes 5 of the user are at focus positions for the aerial image R, the distance-varying portion 4c is located opposite to the eyes 5 of the user across the aerial image R and at a defocus position for the eyes 5 of the user. The distance-varying portion 4c has a varying distance, by location, from a virtual imaging plane of the aerial image. The distance-varying portion 4c may be in, for example, a defocus portion 4b of the housing 4. In other words, the distance-varying portion 4c may be included in the housing 4 or be separate from the housing 4. When the distance-varying portion 4c is separate from the housing 4, the distance-varying portion 4c may be attached to the housing 4 by, for example, bonding or be spaced apart from the housing 4. The distance-varying portion 4c may thus be referred to as the distance-varying portion 4c in a defocus member or the distance-varying portion 4c included in the defocus member. Note that the distance-varying portion 4c described hereafter is included in the defocus portion 4b that is a part of the housing 4.

Being at a focus position for the eyes 5 of the user or being at a defocus position for the eyes 5 of the user herein refers to an object in the field of view of the eyes 5 of the user. An object outside the field of view of the eyes 5 of the user, or in other words, an object that cannot be viewed with the eyes 5 of the user (e.g., a portion of the rear surface or the back surface of the housing 4) is thus excluded.

When the eyes 5 of the user are at the focus positions that are at a distance L1 from the aerial image R in a direction of a visual axis, the housing 4 may include a focus portion 4a and the defocus portion 4b. The focus portion 4a is at a focus position that is at a distance L2 from the eyes 5 of the user in a direction parallel to the visual axis. The defocus portion 4b is at a defocus position that is at a distance L3 from the eyes 5 of the user in the direction parallel to the visual axis. The defocus portion 4b includes the distance-varying portion 4c having a varying distance LR (illustrated in FIG. 2), by location, from a virtual imaging plane Rp of the aerial image R.

The above structure produces the effects described below. The defocus portion 4b includes the distance-varying portion 4c, and thus allows the user to have depth perception with the eyes 5. In other words, the defocus portion 4b includes a portion with a lower degree of defocus (degree of defocus) perceived as being nearer the eyes 5 of the user, and a portion with a higher degree of defocus perceived as being farther from the eyes 5 of the user. The aerial image R is thus more likely to be viewed as popping out toward the user due to the defocus portion 4b, which produces depth perception, located behind the aerial image R (farther than the aerial image R from the eyes 5 of the user). This forms the aerial image R with an improved sense of popping out and floating, thus allowing the aerial image R with improved accuracy of depth recognition to be displayed.

When the aerial image display device 1 includes, as a focus member, the focus portion 4a of the housing 4 at the focus position that is at the distance L2 from the eyes 5 of the user in the direction parallel to the visual axis with the eyes 5 of the user at the focus positions that are at the distance L1 from the aerial image R in the direction of the visual axis, the aerial image R is more likely to be viewed as popping out toward the user due to the focus portion 4a and the defocus portion 4b producing depth perception. More specifically, the portion from the focus portion 4a to the defocus portion 4b producing depth perception allows the user to have depth perception with the eyes 5. The focus portion 4a may be included in the housing 4 or be separate from the housing 4. The focus portion 4a may thus be referred to as the focus member. When the focus portion 4a is separate from the housing 4, the focus portion 4a may be attached to the housing 4 by, for example, bonding or be spaced apart from the housing 4. Note that the focus portion 4a is hereafter a part of the housing 4.

Although the defocus portion 4b at least partially includes the distance-varying portion 4c, the entire defocus portion 4b may be the distance-varying portion 4c as illustrated in FIG. 1. The defocus portion 4b may have 10% or more of its area that is the distance-varying portion 4c, 30% or more of its area that is the distance-varying portion 4c, or 50% or more of its area that is the distance-varying portion 4c, but the ranges are not limited to these ranges. When 50% or more of the area of the defocus portion 4b is the distance-varying portion 4c, the defocus portion 4b allows the user to have depth perception with the eyes 5 easily.

The distance-varying portion 4c in the defocus portion 4b is in a portion of the housing (also referred to as a case) 4 accommodating the optical system 3 that can be viewed with the eyes 5 of the user. In other words, the defocus portion 4b is in the viewable field of view, in which the defocus portion 4b can be viewed, and at substantially the same height position as the aerial image R as viewed from the eyes 5 of the user. The range of the field of view viewable to the eyes 5 of the user is a range of an effective field of view (a viewing angle range of about 30 degrees in a horizontal direction and a viewing angle range of about 20 degrees in a vertical direction). The defocus portion 4b is within the range of the effective field of view of the eyes 5 of the user.

As illustrated in FIG. 6, the distance-varying portion 4c may be located in a frame 4f surrounding an opening serving as an image light emission portion (also referred to as a display) 6 in the housing 4, or may be located in the image light emission portion 6. A light-transmissive cover plate, a light-transmissive screen, or another component made of, for example, glass or plastic may be fitted in the image light emission portion 6. The distance-varying portion 4c may be located in an extension extending, for example, upward or sideward from the frame 4f as viewed from the user.

The distance-varying portion 4c may have a shape with the distance LR varying gradually from the virtual imaging plane Rp of the aerial image R. In this case, the user has, with the eyes 5, depth perception, which is produced by the distance-varying portion 4c, shifting smoothly. The distance-varying portion 4c is thus viewed by the user naturally without causing discomfort to the user. This reduces the likelihood that the distance-varying portion 4c disturbs or reduces the viewability of the aerial image R, thus improving the viewability of the aerial image R. In the present embodiment, the shape with the distance LR varying gradually may be, for example, a flat surface inclined with respect to the visual axis at an angle θ. The angle θ may be, for example, but not limited to, greater than or equal to 5° and less than 90°, about 15 to 70°, or about 30 to 60°. The distance-varying portion 4c having the distance LR varying gradually may not be a flat portion of the aerial image display device 1, and may be a portion of a curved surface. The distance-varying portion 4c may include, for example, protrusions and recesses. Note that a range of values referred to herein as one value to another value intends to mean the two values being inclusive.

The distance-varying portion 4c may have a shape with the distance LR from the virtual imaging plane Rp of the aerial image R that varies in a stepwise manner. For example, the distance-varying portion 4c may be stepped. In this case, the user has, with the eyes 5, depth perception, which is produced by the distance-varying portion 4c, shifting smoothly. The distance-varying portion 4c is thus more likely to be viewed by the user naturally without causing discomfort to the user. This reduces the likelihood that the distance-varying portion 4c disturbs or reduces the viewability of the aerial image R, thus improving the viewability of the aerial image R. With the distance LR that varies in a stepwise manner by a lower degree, the viewability of the aerial image R can be maintained effectively. The degree by which the distance LR varies in a stepwise manner may be, but not limited to, less than or equal to about 5 cm, less than or equal to about 3 cm, or less than or equal to 1 cm.

As illustrated in FIG. 6, the boundary between the distance-varying portion 4c and the focus portion 4a may be located below the aerial image R as viewed from the eyes 5 of the user. In other words, the distance-varying portion 4c may have a greater dimension than the aerial image R in the vertical direction, and may also be located to encompass the aerial image R in a lateral direction (horizontal direction). In this case, the distance-varying portion 4c allows the user to have depth perception with the eyes 5 more effectively, and the aerial image R is more likely to be viewed as further popping out toward the user.

As illustrated in FIG. 6, a contrast caused by external light from the surrounding environment may be added to the aerial image R. For example, when the aerial image display device 1 is receiving the external light from the upper left of the aerial image display device 1, a contrast may be added to the aerial image R to cause the aerial image R to appear receiving the external light from the upper left of the aerial image R. In this case, the aerial image R is viewed more stereoscopically (three-dimensionally) by the user, and is thus more likely to be viewed as further popping out toward the user. The contrast caused by the external light from the surrounding environment may be added to the aerial image R by adding a contrast to an image displayed on the display device 2. In this case, an image data controller may be connected to the display device 2 to control the contrast of image data provided to the display device 2.

The direction and the intensity (luminance) of the external light may be detected using an optical sensor, such as an illuminometer, installed in the aerial image display device 1. One or more optical sensors may be installed.

A contrast may be added to the image displayed on the display device 2 based on the direction and the intensity of the external light detected by the optical sensor. In this case, original image data of the image displayed on the display device 2 may be corrected based on the direction and the intensity of the external light. The process of adding a contrast to the image can be performed with an external device, such as a personal computer or a smartphone, connected to the display device 2.

The degree of contrast (e.g., contrast of light and shade) caused by the external light from the surrounding environment, color tones, or other parameters added to the aerial image R can be set automatically based on a detection value from the optical sensor, but may be adjusted by, for example, the user. For example, the degree of contrast, the color tones, or other parameters may be adjusted by the external device, such as a personal computer or a smartphone, connected to the display device 2. Although a contrast is added to the image by a higher degree in, for example, an environment with strong and bright external light, the degree may be finely adjusted by, for example, the user, and the color tones may be adjusted by, for example, the user. Although a contrast is added by a lower degree in an environment with weak and dark external light, the degree may be finely adjusted by, for example, the user, and the color tones may be adjusted by, for example, the user.

The display device 2 may include a backlight and a transmissive display panel. The transmissive display panel may be a liquid crystal display (LCD) panel that transmits light from the backlight and displays an image with many pixels.

The LCD panel may have a known structure. The known LCD panel may be an in-plane switching (IPS) panel, a fringe field switching (FFS) panel, a vertical alignment (VA) panel, an electrically controlled birefringence (ECB) panel, or any of various other panels. The LCD panel may include a first polarizing plate, a color filter substrate, a liquid crystal layer, an array substrate, and a second polarizing plate. The first polarizing plate may be located adjacent to a display surface of the display device 2.

The optical system 3 may include a first reflective mirror 31 that reflects image light B1 emitted from the display device 2 to generate image light B2 as reflected light, a second reflective mirror 32 that reflects the image light B2 reflected from the first reflective mirror 31 to generate image light B3 as reflected light, and a third reflective mirror 33 that reflects the image light B3 reflected from the second reflective mirror 32 to generate image light B4 as reflected light. The first reflective mirror 31 and the third reflective mirror 33 may be concave mirrors. The second reflective mirror 32 may be a convex mirror. Reflecting surfaces of the concave mirrors and the convex mirror may not be spherical, and may be aspherical. The first reflective mirror 31, the second reflective mirror 32, and the third reflective mirror 33 may be freeform mirrors.

For the distance-varying portion 4c having the flat shape described above with the distance LR varying gradually from the virtual imaging plane Rp of the aerial image R to the housing 4 at a predetermined ratio, L11 is the distance from the eyes 5 to the aerial image R, L12 is the distance from the aerial image R to the focus portion 4a of the housing 4, L13 is the distance from the aerial image R to a nearest portion of the defocus portion 4b of the housing 4, and L14 is the distance from the aerial image R to a farthest portion of the defocus portion 4b of the housing 4 as illustrated in FIG. 2. D1 is a diopter value of the eyes 5 of the user for the aerial image R, D2 is a diopter value of the eyes 5 of the user for the focus portion 4a, D3 is a diopter value of the eyes 5 of the user for a nearest portion of the distance-varying portion 4c, and D4 is a diopter value of the eyes 5 of the user for a farthest portion of the distance-varying portion 4c. The diopter values D1 to D4 are as follows.

$$The diopter value D 1 is 1 / L 11 = 1 / 0.5 = 2. .$$

$$The diopter value D 2 is 1 / ( L 11 + L 12 ) = 1 / ( 0.5 m + 0.2 m ) = 1.43 .$$

$$The diopter value D 3 is 1 / ( L 11 + L 13 ) = 1 / ( 0.5 m + 0.5 m ) = 1. .$$

$$The diopter value D 4 is 1 / ( L 11 + L 14 ) = 1 / ( 0.5 m + 0.8 m ) = 0.77 .$$

A difference ΔD12 (hereafter also referred to as a diopter difference) between the diopter value D1 and the diopter value D2, a difference ΔD13 between the diopter value D1 and the diopter value D3, and a difference ΔD14 between the diopter value D1 and the diopter value D4 are as follows.

$$Δ D 12 = D 1 - D 2 = 2. - 1.43 = 0.57 \qquad ( 1 )$$

$$Δ D 13 = D 1 - D 3 = 2. - 1. = 1. \qquad ( 2 )$$

$$Δ D 14 = D 1 - D 4 = 2. - 0.77 = 1.23 \qquad ( 3 )$$

With the diopter difference ΔD12 expressed by Formula 1 above, the eyes 5 are focused on both the aerial image R and the focus portion 4a. Thus, the aerial image R and the focus portion 4a appear, to the user, to be at substantially the same distance from the eyes 5.

With the diopter difference ΔD13 expressed by Formula 2 above, the eyes 5 are focused on the aerial image R, but are not focused on the nearest portion of the defocus portion 4b of the housing 4. Thus, the nearest portion of the defocus portion 4b appears, to the user, to be located rearward from the aerial image R.

With the diopter difference ΔD14 expressed by Formula 3 above, the eyes 5 are focused on the aerial image R, but are not at all focused on the farthest portion of the defocus portion 4b of the housing 4. Thus, the farthest portion of the defocus portion 4b appears, to the user, to be located more rearward from the aerial image R. As described above, the aerial image R is more likely to be viewed as popping out toward the user as illustrated in FIG. 6 due to the defocus portion 4b producing depth perception.

When the aerial image R is viewed by the user, the aerial image display device 1 in the background of the aerial image R is viewed at the same time and the aerial image R appears popping out in air effectively under the conditions below. Formulas 4 to 6 below may be satisfied, where D1, D2, D3, and D4 are respectively the diopter values of the eyes 5 of the user for the aerial image R, the focus portion 4a of the housing 4, the nearest portion of the distance-varying portion 4c, and the farthest portion of the distance-varying portion 4c as described above.

$$( D 1 - D 2 ) < 1 \qquad ( 4 )$$

$$( D 1 - D 3 ) \geq 1 \qquad ( 5 )$$

$$( D 1 - D 4 ) > ( D 1 - D 3 ) \qquad ( 6 )$$

When the eyes 5 of the user are too far from the aerial image R, the eyes 5 are focused on all of the aerial image R, the focus portion 4a of the housing 4, and the defocus portion 4b of the housing 4. The aerial image R, the focus portion 4a of the housing 4, and the defocus portion 4b of the housing 4 thus appear to be at the same distance from the eyes 5. The aerial image R thus has a lower sense of popping-out and floating, and may be viewed with a sense of depth less easily. Thus, L11 may be about 0.2 to 1 m.

The distance-varying portion 4c has the shape with the distance varying gradually from the virtual imaging plane Rp of the aerial image R at the predetermined ratio. The predetermined ratio is defined as Lc2/Lc1 (ΔLc2/ΔLc1) that may be greater than or equal to 0.1, where Lc1 (also referred to as ΔLc1) is a change in the location, and Lc2 (also referred to as ΔLc2) is a change in the distance from the virtual imaging plane Rp of the aerial image R. This allows the distance-varying portion 4c in the defocus portion 4b, which is a part of the housing 4, to produce depth perception easily within the size (e.g., a height of about 0.1 to 1 m) of the housing 4. Lc2/Lc1 may be, but not limited to, about 0.1 to 5, about 0.3 to 3, or about 0.5 to 2.

The diopter values D3 and D4 for the distance-varying portion 4c may vary gradually from the diopter value D3 of the nearest portion toward the diopter value D4 of the farthest portion. This allows the distance-varying portion 4c in the defocus portion 4b, which is a part of the housing 4, to produce depth perception easily within the size (e.g., a height of about 0.1 to 1 m) of the housing 4.

The distance-varying portion 4c may have a larger area than the focus portion 4a. In this case, the distance-varying portion 4c allows the user to have depth perception with the eyes 5 easily. The area of the distance-varying portion 4c may be, but not limited to, greater than one time and not more than about ten times the area of the focus portion 4a.

The distance-varying portion 4c and the focus portion 4a may differ in lightness. In this case, the focus portion 4a and the distance-varying portion 4c in the defocus portion 4b differ in viewability. The focus portion 4a and the distance-varying portion 4c in the defocus portion 4b can thus be easily distinguished to be viewed. Thus, for example, when the distance-varying portion 4c has higher lightness than the focus portion 4a, the distance-varying portion 4c in the defocus portion 4b has higher viewability than the focus portion 4a, and allows the user to have depth perception with the eyes 5 easily.

Lightness can be expressed by the values of colors of objects defined in the Munsell color system. Lightness is determined with reference to neutral colors such as white, black, and gray. The lightest white is assigned with 10. The darkest black is assigned with 0. Grays are assigned with numbers ranging from 1 to 9. Actual color samples are unlikely to include a sample that totally reflects light (value 10) and a sample that totally absorbs light (value 0). Thus, white is often assigned with 9.5, and black is often assigned with 1. The difference in lightness between the distance-varying portion 4c and the focus portion 4a may be, but not limited to, greater than or equal to 1, or greater than or equal to 2. The difference in lightness between the distance-varying portion 4c and the focus portion 4a may be, but not limited to, less than or equal to 8, less than or equal to 5, or less than or equal to 3. For example, the distance-varying portion 4c may be gray, and the focus portion 4a may be black.

Lightness may be different based on the color. Light colors (also referred to as warm colors) include, for example, white, pink, orange, and red. Dark colors (also referred to as cool colors) include, for example, black, dark blue, brown, purple, and gray. A lighter color has higher lightness, and a darker color has lower lightness. This may be used to allow the distance-varying portion 4c and the focus portion 4a to differ in lightness.

The distance-varying portion 4c may have lower lightness than the focus portion 4a. For example, when the distance-varying portion 4c has a larger area than the focus portion 4a and the distance-varying portion 4c has lower lightness than the focus portion 4a, the larger distance-varying portion 4c having lower lightness is located behind the aerial image R as viewed from the user. This improves the viewability of the aerial image R.

The lightness of the distance-varying portion 4c may change by location. For example, the lightness of the distance-varying portion 4c may decrease as the distance from the eyes 5 of the user increases. In this case, the distance-varying portion 4c allows the user to have depth perception with the eyes 5 more easily. For example, the distance-varying portion 4c may turn gray, gray-black, and black as the distance from the eyes 5 of the user increases.

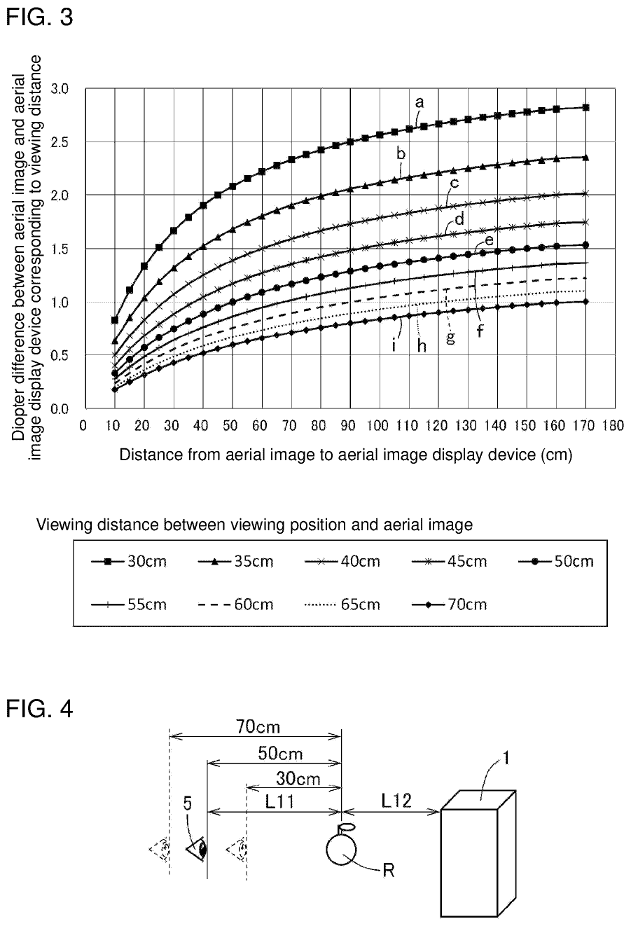

FIG. 3 is a graph showing the relationship between the distance from the aerial image R to the aerial image display device 1 and the diopter difference. FIG. 4 is a perspective view of the eyes 5 of the user, the aerial image R, and the aerial image display device 1 illustrating their positional relationships. In FIG. 3, the square marks on line a indicate that a viewing distance A between the eyes 5 and the aerial image R is 30 cm. The triangular marks on line b indicate that the viewing distance is 35 cm. The cross marks on line c indicate that the viewing distance is 40 cm. The asterisk marks on line d indicate that the viewing distance is 45 cm. The circular marks on line e indicate that the viewing distance is 50 cm. The plus marks on line f indicate that the viewing distance is 55 cm. The dash marks on line g indicate that the viewing distance is 60 cm. The dot marks on line h indicate that the viewing distance is 65 cm. The diamond marks on line i indicate that the viewing distance is 70 cm.

As illustrated in FIG. 4, the aerial image R may be formed at a position 30 to 70 cm away from the viewing position of the user based on a combination of the viewability for the user viewing the aerial image R and an infrared motion sensor (having appropriate detection sensitivity at a distance of 20 cm to 3 m). In this case, as shown in FIG. 3, when, with the diopter difference greater than or equal to 1.0, the aerial image R is brought into focus at the viewing position, or the positions of the eyes 5, the viewpoint of the user is not focused on the aerial image display device 1. The user can thus view the aerial image R clearly. The aerial image R can thus be viewed as a highly sharp three-dimensional image, with an improved sense of floating, popping-out, and depth. When the aerial image R is brought into focus at the viewing position with the diopter difference less than 1.0, a surface of the aerial image display device 1 facing the user is also brought into focus, thus the aerial image R has a lower sense of floating, popping out, and depth.

Although lines a to i satisfy Formulas 4 and 5 above in FIG. 3, lines b (the viewing distance of 35 cm) to h (the viewing distance of 65 cm) substantially include both the range with the diopter difference less than or equal to 1.0 and the range with the diopter difference greater than or equal to 1.0. The distances corresponding to lines b to h may thus be used.

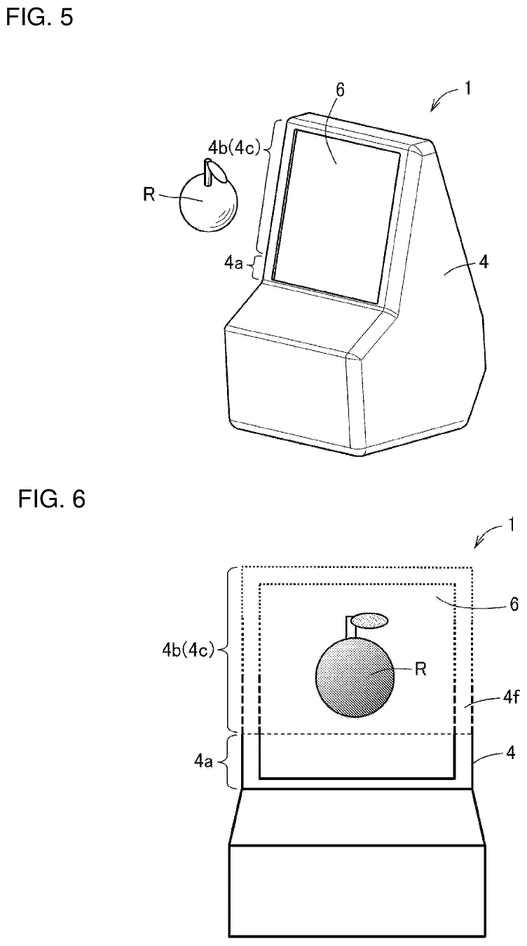

FIG. 5 is a perspective view of the aerial image display device 1, illustrating an example appearance. FIG. 6 is a front view of the aerial image display device 1. In the aerial image display device 1, the image light emission portion 6 may be the display. In this case, the display may be a light-transmissive screen. An image projector may be at an upper and obliquely rearward position in the aerial image display device 1. An image projected from the image projector may be displayed on the light-transmissive screen. Image light from the optical system 3 accommodated in the housing 4 passes through the light-transmissive screen. The aerial image display device 1 can display the aerial image R in a front space away from the display 6 toward the user, while displaying the projected image on the display 6. In the present embodiment, the aerial image display device 1 allows the aerial image R to appear popping out forward from the projected image in the background more effectively. In other words, the display 6 includes the focus portion 4a that is focused by the user and the defocus portion 4b that is not focused by the user, and displays the aerial image R in an area of the defocus portion 4b corresponding to the eyes 5 of the user. This allows the user to view the aerial image R with a higher sense of popping-out, floating, and depth.

For the image light emission portion 6 that is the display such as a light-transmissive screen, the display may serve as the defocus portion. For example, the display may display an image with a low degree of defocus (a blur of focus) in its lower portion, and display an image with a high degree of defocus in its upper portion. In this case, the display allows the user to have depth perception with the eyes 5 in the same manner as or in a similar manner to the distance-varying portion 4c. The display serving as the defocus portion may be another aerial image.

The frame 4f of the housing 4 may include the defocus portion 4b including the distance-varying portion 4c, and the image light emission portion 6 may be the display that displays a defocus image with different degrees of defocus. In this case, the distance-varying portion 4c and the defocus image with different degrees of defocus allow the user to have depth perception with the eyes 5 more effectively. When the distance-varying portion 4c is defined as a first portion having a defocus difference and the defocus image with different degrees of defocus displayed by the display is defined as a second portion having a defocus difference, the first portion having a defocus difference and the second portion having a defocus difference may differ in degree of change in the defocus. For example, the degree of change in the defocus in the first portion having a defocus difference may be higher than the degree of change in the defocus in the second portion having a defocus difference. This allows the user to have depth perception with the eyes 5 more effectively.

The housing 4 may substantially include no frame 4f, or in other words, the housing 4 may be frameless, and the image light emission portion 6 may be the display that displays the defocus image with different degrees of defocus. In this case, the second portion having a defocus difference has a larger area, thus allowing the user to have depth perception with the eyes 5 more effectively. The housing 4 substantially including no frame 4f may be the housing 4 including a thinner frame 4f unperceivable to the eyes 5 of the user. For example, the frame 4f may have a width of about 0.1 to 3 mm, or about 0.1 to 1 mm. The housing 4 may not include at least a part of the frame 4f. For the display that is rectangular in a front view, for example, the frame 4f may include no left portion and no right portion when the display is viewed from the front. However, the housing 4 may include a left side wall and a right side wall.

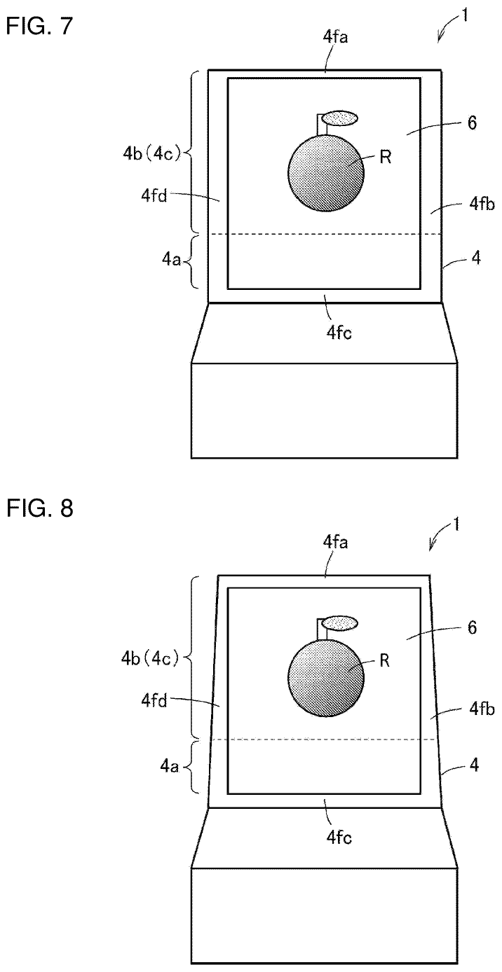

FIGS. 7 to 10 each illustrate an aerial image display device 1 according to another embodiment of the present disclosure. The structure in FIG. 7 is the same as or similar to the structure in FIG. 6. The frame 4f that is rectangular in a front view includes an upper portion 4fa with a width smaller than each of the widths of a right portion 4fb and a left portion 4fd adjacent to the upper portion 4fa. In this case, the upper portion 4fa of the frame 4f is viewed with the eyes 5 of the user as being farther than the right portion 4fb, the left portion 4fd, and a lower portion 4fc. In other words, depth perception produced by the defocus portion 4b can be emphasized. The aerial image R is thus more likely to be viewed as further popping out toward the user. The thickness of the upper portion 4fa of the frame 4f may be, but not limited to, greater than or equal to 0.1 times and less than one time, or about 0.1 to 0.5 times, the width of each of the right portion 4fb and the left portion 4fd.

The structure in FIG. 8 is the same as or similar to the structure in FIG. 6. The frame 4f that is rectangular in a front view includes the right portion 4fb and the left portion 4fd each with a width decreasing (narrowing) upward. In this case, the upper portion 4fa of the frame 4f is viewed with the eyes 5 of the user as being farther than the right portion 4fb, the left portion 4fd, and a lower portion 4fc. In other words, depth perception produced by the defocus portion 4b can be emphasized. The aerial image R is thus more likely to be viewed as further popping out toward the user. The widths of the right portion 4fb and the left portion 4fd of the frame 4f may decrease upward gradually or in a stepwise manner. The widths of the right portion 4fb and the left portion 4fd of the frame 4f may decrease upward nonlinearly (curvedly).

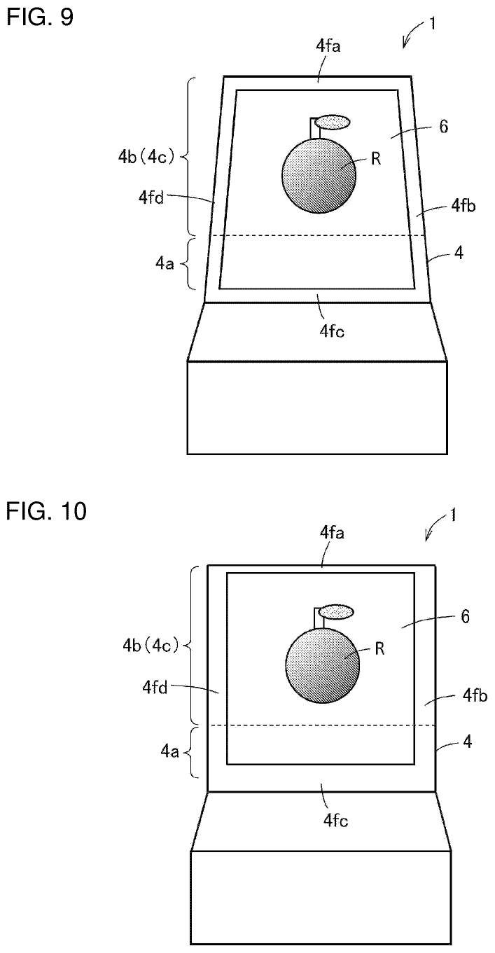

The structure in FIG. 9 is the same as or similar to the structure in FIG. 6. The frame 4f that is rectangular in a front view has a dimension decreasing (narrowing) upward. In this case, the upper portion 4fa of the frame 4f is viewed with the eyes 5 of the user as being farther than the right portion 4fb, the left portion 4fd, and a lower portion 4fc. In other words, depth perception produced by the defocus portion 4b can be emphasized. The aerial image R is thus more likely to be viewed as further popping out toward the user. The dimension of the frame 4f may decrease upward gradually or in a stepwise manner. The dimension of the frame 4f may decrease upward nonlinearly (curvedly).

The structure in FIG. 10 is the same as or similar to the structure in FIG. 6. The frame 4f that is rectangular in a front view includes the lower portion 4fc with a width greater than the width of the upper portion 4fa. In this case, the upper portion 4fa of the frame 4f is viewed with the eyes 5 of the user as being farther than the lower portion 4fc. In other words, depth perception produced by the defocus portion 4b can be emphasized. The aerial image R is thus more likely to be viewed as further popping out toward the user. The width of the lower portion 4fc of the frame 4f may be, but not limited to, greater than one time and not more than about ten times, or about 1.5 to 5 times, the width of the upper portion 4fa.

The frame 4f may not be rectangular in a front view, and may have any shape with which the upper portion 4fa, the right portion 4fb, the left portion 4fd, and the lower portion 4fc are substantially perceivable. For example, the frame 4f may have any shape such as a trapezoid, a parallelogram, a circle, an oval, or an ellipse in a front view. In the structures in FIGS. 7 to 10, the image light emission portion 6 may serve as the display. An image with a degree of defocus increasing upward may be displayed on the display. In this case, depth perception produced by the defocus portion 4b can be emphasized. The aerial image R is thus more likely to be viewed as further popping out toward the user. At least two of the structures in FIGS. 7 to 10 may be combined.

In one or more embodiments of the present disclosure, the aerial image display device can use, as the display device 2, a liquid crystal display device (light emitting diode or LED) or a self-luminous display device such as an organic EL display device. In one or more embodiments of the present disclosure, the aerial image display device allows an operation of aerial images without touching, and may be used in, but not limited to, products in various fields described below. Examples of such products include a communication device for communication or conversations using aerial images, a medical interview device that allows doctors to interview patients using aerial images, a navigation device and a driving control device for vehicles such as automobiles, an order reception and registration device used in, for example, shops, an operational panel used in, for example, buildings or elevators, a learning device for teaching or learning classes using aerial images, an office device for business communication or instructions using aerial images, a gaming device used for playing games using aerial images, a projector for projecting images on the ground or walls in, for example, amusement parks or game arcades, a simulation device for simulation using aerial images in, for example, universities or medical organizations, a large display for displaying prices and other information in, for example, markets or stock exchanges, and a video viewing device used for viewing aerial videos.

In one or more embodiments of the present disclosure, the aerial image display device forms an aerial image with an improved sense of popping out and floating and displays an aerial image with improved accuracy of depth recognition.

The structure according to one or more embodiments of the present disclosure may have aspects (1) to (12) described below.

(1) An aerial image display device, comprising:
a display device;
an optical system configured to form, as a real image, an aerial image from image light emitted from the display device; and
a distance-varying portion located opposite to an eye of a user across the aerial image and at a defocus position for the eye of the user when the eye of the user is at a focus position for the aerial image, the distance-varying portion having a varying distance, by location, from a virtual imaging plane of the aerial image.

(2) The aerial image display device according to aspect (1), further comprising: a focus portion at a focus position for the eye of the user.

(3) The aerial image display device according to aspect (1) or aspect (2), wherein the distance-varying portion has a shape with a distance varying gradually from the virtual imaging plane of the aerial image.

(4) The aerial image display device according to aspect (3), wherein the distance-varying portion has a shape with the distance varying gradually from the virtual imaging plane of the aerial image at a predetermined rate, and the predetermined rate is defined as Lc2/Lc1 being greater than or equal to 0.1, where Lc1 is a change in the location, and Lc2 is a change in the distance from the eye of the user.

(5) The aerial image display device according to aspect (2), wherein the distance-varying portion has a larger area than the focus portion.

(6) The aerial image display device according to aspect (2) or aspect (5), wherein the distance-varying portion and the focus portion differ in lightness.

(7) The aerial image display device according to aspect (6), wherein the distance-varying portion has higher lightness than the focus portion.

(8) The aerial image display device according to aspect (2), further comprising:
a defocus portion at a defocus position for the eye of the user,
wherein (D1−D2)<1, (D1−D3)≥1, and (D1−D4)>(D1−D3), where D1 is a diopter value of the eye of the user for the aerial image, D2 is a diopter value of the eye of the user for the focus portion, D3 is a diopter value of the eye of the user for a nearest portion of the distance-varying portion in the defocus portion, and D4 is a diopter value of the eye of the user for a farthest portion of the distance-varying portion in the defocus portion.

(9) The aerial image display device according to aspect (8), wherein
the diopter value for the distance-varying portion varies gradually from the nearest portion toward the farthest portion.

(10) The aerial image display device according to any one of aspects (1) to (9), wherein
the aerial image display device is configured to add, to the aerial image, a contrast caused by external light from a surrounding environment are added.

(11) The aerial image display device according to aspect (10), further comprising: an optical sensor configured to detect a direction and intensity of the external light, wherein the aerial image display device is configured to add a contrast to an image displayed on the display device based on a detection value from the optical sensor.

(12) The aerial image display device according to aspect (11), wherein the aerial image display device is configured to allow the user to further adjust a contrast of the image to which a contrast is added based on the detection device from the optical sensor.

Although one or more embodiments of the present invention have been described in detail, the present invention is not limited to the embodiments described above, and may be changed or varied in various manners without departing from the spirit and scope of the present invention. The components described in the above embodiments may be entirely or partially combined as appropriate unless any contradiction arises.

### REFERENCE SIGNS

1 aerial image display device
2 display device
3 optical system
4 housing
4a focus portion
4b defocus portion
4c distance-varying portion
5 eyes of user
6 display (image light emission portion)
31 first reflective mirror
32 second reflective mirror
33 third reflective mirror
B1, B2, B3 image light
L1, L2, L3, L11, L12 distance
LR distance of defocus portion from virtual imaging plane of aerial image
R aerial image
Rp virtual imaging plane of an aerial image

1. An aerial image display device, comprising:
a display device;
an optical system configured to form, as a real image, an aerial image from image light emitted from the display device; and
a distance-varying portion located opposite to an eye of a user across the aerial image and at a defocus position for the eye of the user when the eye of the user is at a focus position for the aerial image, the distance-varying portion having a varying distance, by location, from a virtual imaging plane of the aerial image.

2. The aerial image display device according to claim 1, further comprising:
a focus portion at a focus position for the eye of the user.

3. The aerial image display device according to claim 1, wherein
the distance-varying portion has a shape with a distance varying gradually from the virtual imaging plane of the aerial image.

4. The aerial image display device according to claim 3, wherein
the distance-varying portion has a shape with the distance varying gradually from the virtual imaging plane of the aerial image at a predetermined rate, and
the predetermined rate is defined as Lc2/Lc1 being greater than or equal to 0.1, where Lc1 is a change in the location, and Lc2 is a change in the distance from the virtual imaging plane of the aerial image.

5. The aerial image display device according to claim 2, wherein
the distance-varying portion has a larger area than the focus portion.

6. The aerial image display device according to claim 2, wherein
the distance-varying portion and the focus portion differ in lightness.

7. The aerial image display device according to claim 6, wherein
the distance-varying portion has higher lightness than the focus portion.

8. The aerial image display device according to claim 2, further comprising:
a defocus portion at a defocus position for the eye of the user,
wherein (D1−D2)<1, (D1−D3)≥1, and (D1−D4)>(D1−D3), where D1 is a diopter value of the eye of the user for the aerial image, D2 is a diopter value of the eye of the user for the focus portion, D3 is a diopter value of the eye of the user for a nearest portion of the distance-varying portion in the defocus portion, and D4 is a diopter value of the eye of the user for a farthest portion of the distance-varying portion in the defocus portion.

9. The aerial image display device according to claim 8, wherein
the diopter value for the distance-varying portion varies gradually from the nearest portion toward the farthest portion.

10. The aerial image display device according to claim 1, wherein
The aerial image display device is configured to add, to the aerial image, a contrast caused by external light from a surrounding environment.

11. The aerial image display device according to claim 10, further comprising:
an optical sensor configured to detect a direction and intensity of the external light,
wherein the aerial image display device is configured to add a contrast to an image displayed on the display device based on a detection value from the optical sensor.

12. The aerial image display device according to claim 11, wherein
the aerial image display device is configured to allow the user to further adjust a contrast of the image to which a contrast is added based on the detection device from the optical sensor.
